(19) United States
(12) Patent Application Publication
(10) Pub. No.: US 2009/0107567 A1
(43) Pub. Date: Apr. 30, 2009

(54) Combination water tower and electrical wind turbine generator

(76) Inventor: Peter B. Crary, Fargo, ND (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/288,628

(22) Filed: Oct. 22, 2008

Related U.S. Application Data
(60) Provisional application No. 61/000,529, filed on Oct. 26, 2007.

(51) Int. Cl. E04H 12/30; F03D 9/00; E03B 11/00

(52) U.S. Cl. 137/560; 137/565.01; 290/55; 52/40

(57) ABSTRACT

A combination tower includes a first elevating section, a second elevating section, a storage tank located above the first elevating section, and a wind turbine attached to the top of the second elevating section. The first elevating section is capable of supporting the second elevating section, storage tank, and wind turbine.

### BACKGROUND

This invention relates to a combination of an elevated storage tank for the storing of liquids and a wind turbine power generator.

Municipalities commonly provide utilities to residents in the form of water and sewer. Similarly, residents also obtain electricity from a utility company or municipality. Both of these utilities are necessary for the health and safety of residents.

Elevated water storage tanks, which are sometimes referred to as water towers, have been constructed for use in municipalities to create adequate water pressure throughout the municipality. In general, the prior art storage tanks have been constructed of either metal or concrete and stand more that ten meters tall. Water is pumped to the elevated storage tank, which in turn creates pressure for the municipalities' water system.

A great deal of interest is presently being shown in the development of alternative energy sources. One type of energy in which people are showing interest in is wind power. New and more efficient wind turbine generators are being developed, but these need to be placed on towers which are easy and economical to erect.

Large towers, ten meters or taller, are needed to support wind turbines and the towers need to withstand strong lateral forces caused by the wind. These towers have in the past required guy wires, large base areas, and are generally not very aesthetic. Other towers have been created which are segments of frustroconical sections attached together. Turbine tower construction and turbine maintenance are considerably expensive to.

### SUMMARY

Disclosed is a combination tower having a first elevating section, a second elevating section, a storage tank located above the first elevating section, and a wind turbine attached to the top of the second elevating section. The first elevating section is capable of supporting the second elevating section, storage tank, and wind turbine.

In a second embodiment, the invention is a utility system for a municipality that has a tower with an elevated storage tank and a tower section above the elevated storage tank. The system also has a wind turbine attached to the top of the tower section for generating electrical power. Further, the system has a water system including the storage tank, an inlet pipe into the storage tank, and outlet pipe for discharging a fluid from the storage tank, and at least one pump connected to the inlet pipe for pumping the fluid into the storage tank. Also, the system has access to a power grid, and a power transforming system capable of introducing the electrical power generated by the wind turbine into the power grid.

In another embodiment, the invention is a combination tower having a first elevating section for use as a water tower and a second elevating section having a wind turbine attached to a top portion thereof. The second elevating section is connected to the first elevating section in such a manner as to reduce the stress associated with operation of the wind turbine from substantially affecting the first elevating section.

### BRIEF DESCRIPTION OF THE DRAWINGS

FIG. 1 is a perspective view of a combination tower with a wind turbine and an elevated storage tank.

FIG. 1A is a perspective view of an alternate embodiment of a combination tower with a wind turbine and an elevated storage tank.

FIG. 2 is an elevation view, partly broken away, illustrating the elevated storage tank of the combination tower.

FIG. 3 is a perspective view illustrating the components of the wind turbine of the combination tower.

FIG. 4 is an elevation view of an alternate embodiment of the combination tower.

FIG. 5 is an elevation view of another alternate embodiment of the combination tower.

FIG. 6 is an elevation view of another alternate embodiment of the combination tower.

FIG. 7 is an elevation view of a different side of the embodiment of the combination tower illustrated in FIG. 6.

FIG. 8 is an elevation view of another alternate embodiment of the combination tower.

FIG. 9 is an elevation view of an alternate embodiment of an elevated storage tank with a wind turbine attached to the top of a tower extending from the elevated storage tank.

FIG. 10 is an elevation view of an alternate embodiment of an elevated storage tank with a wind turbine attached to the top of a tower extending above the elevated storage tank.

### DETAILED DESCRIPTION

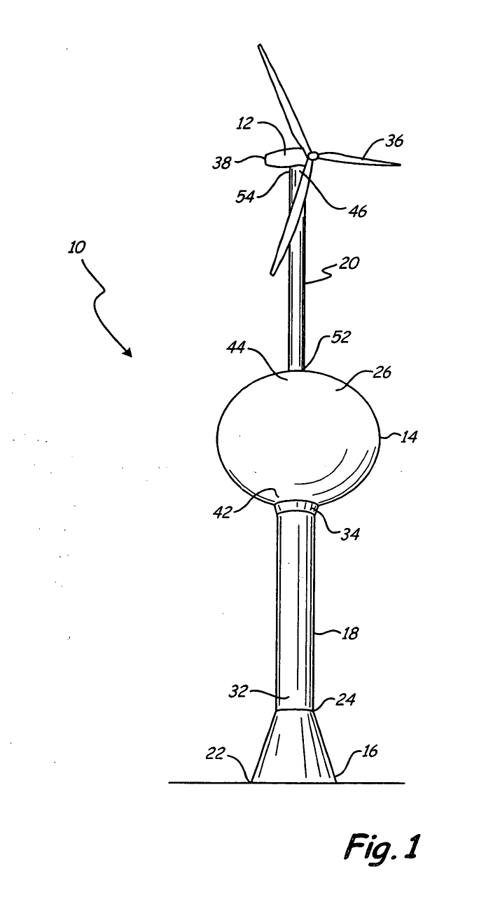

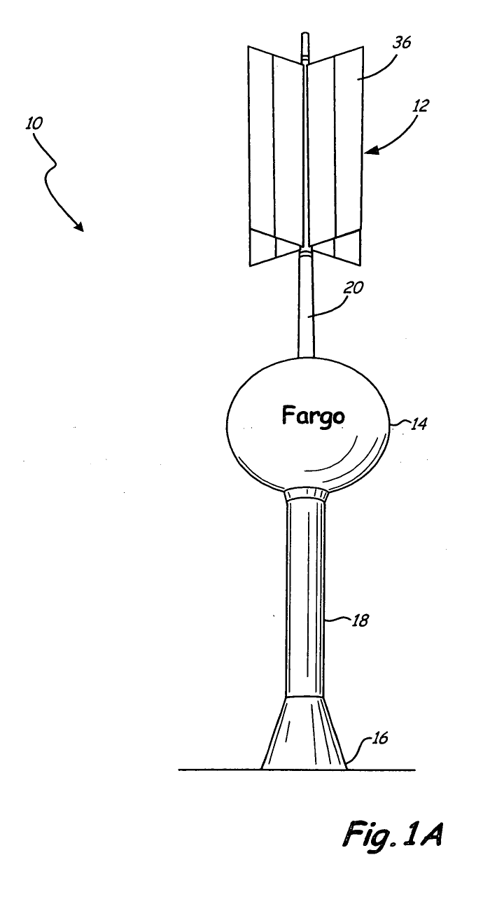

FIG. 1 shows a combination tower 10 with a wind turbine 12 and elevated storage tank 14. Combination tower 10 has base portion 16, first elevating section 18, elevated storage tank 14, second elevating section 20, and wind turbine 12. Base portion 16 may extend into the ground, or be anchored to the ground. Base portion 16 is connected to first elevating section 18. In the embodiment illustrated, base portion 16 is constructed from metal and is generally frustaconical in shape. Lower surface 22 is adjacent the ground and contains a larger perimeter than upper surface 24.

First elevating section 18 is attached base portion 16. First elevating section 18 has upper surface 34 and lower surface 32, which is adjacent upper surface 24. First elevating section is constructed from annular metal sections. The interior of first elevating section 18 may be hollow. In alternate embodiments, the interior of first elevating section 18 contains support structures for stabilizing the tower 10. In one embodiment, first elevating section 18 is at least 10 meters tall, and has a diameter of at least 2.5 meters. In exemplary embodiments, first elevating section 18 is 15 to 50 meters tall, and contains a diameter of 3 to 15 meters.

Upper surface 34 of first elevating section 18 is attached to lower surface 42 of elevated storage tank 14. In this view, elevated storage tank is generally spherical with upper surface 44 and lower surface 42. Elevated storage tank 14 is constructed from curved metal plates or sheets secured together by processes well known in the art, including welding. Elevated storage tank 14 is used for the storage of a material, an in one embodiment, is used to store water in a municipal water system to create pressure within the water system. In one embodiment, tank dimensions are such that the volume of elevated storage tank 14 exceeds 350 kL. In exemplary embodiments, elevated storage tank 14 has a volume of 450 kL to 15,000 kL, depending on the needs of the system in which elevated storage tank 14 is placed.

Second elevating section 20 contains lower surface 52 and upper surface 54. Lower surface 52 is attached to upper surface 44 of elevated storage tank 14. Second elevating section 20 is constructed from annular metal sections, and is either cylindrical or frustaconical in shape. The interior of second elevating section 20 may be hollow. In alternate embodiments, the interior of second elevating section 20 contains support structures for stabilizing combination tower 10. In one embodiment, second elevating section 20 is at least 5 meters tall, and has a diameter of at least 1 meter. In exemplary embodiments, second elevating section 20 is 10 to 75 meters tall, and contains a diameter of 1 to 10 meters at the largest cross-sectional area.

Wind turbine 12 has blades 36 and nacelle 38. Bottom surface 40 of nacelle 38 is attached to the upper surface 44 of second elevating section 20 through pivoting joint 46. Pivoting joint 46 allows for the rotation of nacelle 38 and blades 36 to position blades 36 for optimal performance with the wind or air currents present.

First elevating section 18 is designed to support wind turbine 12, elevated storage tank 14, and second elevating section 20. Elevated storage tank 14 will have varying weight depending on the level to which it is filled. During operation, a typical wind turbine 12 will create vibrations and other motions to its corresponding support structure. The motion created by wind turbine 12 will be translated to the attached structures, which includes second elevating section 20. Second elevating section 20 is connected to elevated storage tank 14, and the motion of wind turbine 12 may be translated to elevated storage tank 14 and any contents therein. The contents of elevated storage tank 14 may vary depending upon usage requirements, and thus is not a static amount. The motion translated to elevated storage tank 14 will create different loads and stresses on the first elevating section 18 depending on the amount of contents in elevated storage tank 14 and the motion of blades 36 of wind turbine 12. As such, first elevating section 18 must be designed to withstand not only the weight of the structures (elevated storage tank 14, second elevating tower 18, and wind turbine 12) located above it, but also account for vibration and motion associated with the structures.

FIG. 1A is a perspective view of an alternate embodiment of a combination tower 10 with a wind turbine 12 and an elevated storage tank 14. Combination tower 10 has base portion 16, first elevating section 18, elevated storage tank 14, and second elevating section 20. Wind turbine 12 is of a different design, and contains a series of paddles that act as blades 36. As air moves, it will strike the blades 36 and cause the paddle assembly to turn on a mount that is coaxial with second elevating section 20. In this embodiment, there is no need for a pivotal nacelle to turn the blades to optimize harvesting of wind power as blades 36 are always present in the path of the wind. Blades 36 can be made of a rigid material, including a light metal such as aluminum, wood, manmade composites, polymers, or similar materials. In an alternate embodiment, blades 36 are constructed from a flexible material that may oscillate with air currents, including rubber, aromatic polyamide fiber clothes, textiles, fabrics, leather, foils, papers, or similar materials.

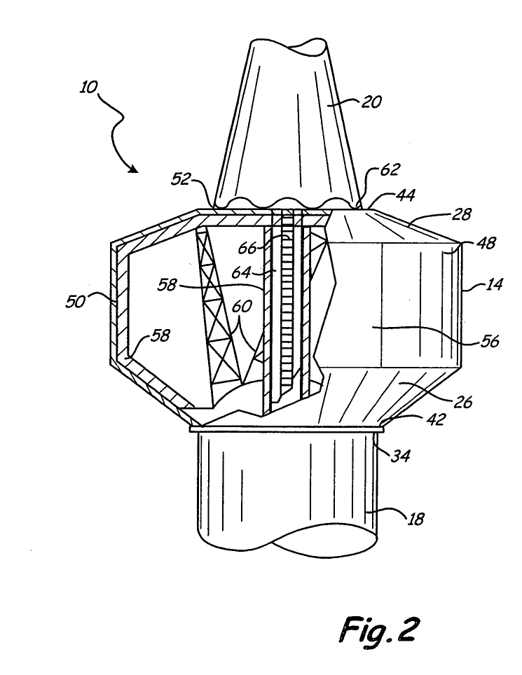

FIG. 2 is a partial cross-section of one embodiment of elevated storage tank 14. Elevated storage tank has a frustaconical bottom surface 26, which has a lower surface 42 attached to upper edge 34 of first elevating section 18, and a frustaconical upper surface 28 which has upper surface 44 attached to second elevating section 20. Middle section 48 extends between bottom surface 26 and upper surface 28, and is generally cylindrical in shape with an interior surface 50.

In this view, elevated storage tank 14 is typically constructed from metal sheets 56 attached together, such as by welding or the use of fasteners such as rivets for bolts. Interior surface 50 contains liner 58. Liner 58 is constructed from a dielectric material, such as rubber. Liner 58 protects the contents of elevated storage tank 14 from any unforeseen events wherein power generated from the attached turbine strays from designated utility lines. Liner 58 may also act to dampen any motion experienced by the contents of elevated storage tank 14.

Elevated storage tank also contains supports 60. In an exemplary embodiment, supports 60 are I-beams constructed from a rigid material such as metal. Supports are secured to interior surface 50 of elevated storage tank 14. In the embodiment illustrated, supports 60 extend from upper surface 44 to lower surface 42. In exemplary embodiments, supports 60 extend from various walls of elevated storage tank 14 to adjacent walls, or from a point on interior surface 50 to another point on interior surface 50 in the case of curved or arced side wall elevated storage tanks. Supports 60 may act as baffles to reduce motion of the contents of elevated storage tank 14.

Elevated storage tank 14 is attached to second elevating section 20 adjacent lower surface 52. Stress reduction pads 62 are secured between elevated storage tank 14 and second elevating section 20. Stress reduction pads 62 are constructed from a resilient material. As illustrated in FIG. 1, turbine 12 is attached to second elevating section 20. Blades 36 will rotate about an axis generally perpendicular to the axis of the second elevating section 20. During operation, the motion of blades 36 creates vibrations and other residual forces on second elevating section 20. Stress reduction pads 62 minimize the amount of vibration experienced by elevated storage tank 14, and thus the effects on the contents of elevated storage tank 14. Similarly, supports 60 are strategically placed to assure vibrations from the attached turbine do not affect the structural integrity of elevated storage tank 14.

Elevated storage tank 14 also contains access passage 64. Access passage 64 is a hollow tube extending from the base of first elevating section 18 to adjacent the upper surface 54 of second elevating section 20. Access passage 64 contains ladder 66, which allows for maintenance personnel to access the turbine 12. Access passage 64 may also contain utility lines, tubes, or pipes for transferring contents to elevated storage tank 14, or running power generated from turbine 12 to an attached power grid. In one embodiment, the portion of access passage 64 within the interior of tank 14 is covered with liner 58.

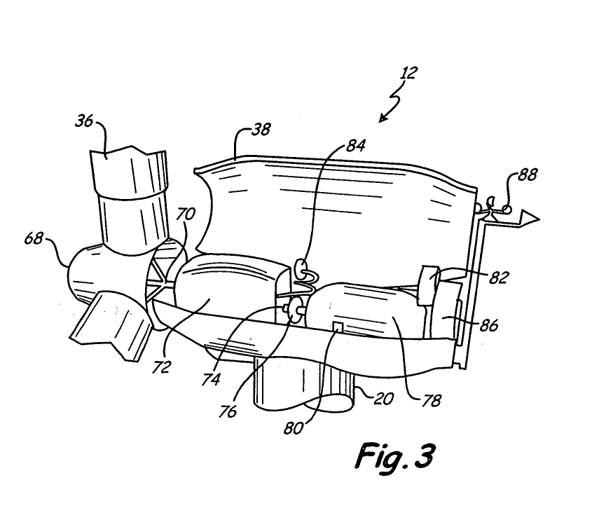

FIG. 3 is a perspective view of the components of wind turbine 12. Wind turbine 12 has rotor blades 36 are mounted on hub 68, and connected to nacelle 38 through low speed shaft 70. Blades 36 may be constructed from fiber glass reinforced plastics such as glass fiber reinforced polyester or epoxy, or by using carbon fiber or aramid fiber to reinforce a base material. Similarly, wood, wood-epoxy, or wood-fiber-epoxy composites, and steel, aluminum, and similar alloys may be used for smaller blades 36. Blades 36 have the appearance of the wings of an aircraft and contain thick profiles in the innermost part of blade 36, but are designed specifically for wind turbines 12. Blades 36 are designed to have reliable lift and stall characteristics, and to perform well in the presence of small particulate matter in the air and on the surface of blade 36, such as from dirt in the wind. Blades may be sized from a few meters in length, up to approximately 30 meters in length or greater.

Hub 68 is constructed from similar materials as blades 36, or a higher strength material for mounting of blades 36. Low speed shaft 70 is connected to hub 68. Low speed shaft 70 is constructed from a light weight, high strength metal or similar material. Low speed shaft 70 provides the axis about which hub 68 with attached blades 36 rotate, and is connected to the components contained within nacelle 38. Low speed shaft 70, as well as the parts connected thereto, typically rotates at less than 50 revolutions per minute (rpm), and more typically between 10 and 30 rpm.

Nacelle 38 houses the components of wind turbine 12, including gearbox 72, high speed shaft 74, brake 76, generator 78, yaw mechanism 80, electronic controller 82, hydraulic system 84, cooling unit 86, and anemometer and wind vane 88. Nacelle 38 may be constructed form fiber glass or a light weight metal. Nacelle 38 is generally cylindrical in shape for aerodynamics, and is constructed of two parts hinged together to allow maintenance personnel access to the components contained therein.

Low speed shaft 70 is connected to gearbox 72 contained within nacelle 38. Gear box 72 connects low speed shaft 70 to high speed shaft 74. Gearbox 72 will translate the rmp of low speed shaft up by multiplier, typically by 50 or more, to high speed shaft 74. High speed shaft 74 rotates much higher speeds, such as 1500 rpm, and drives electrical generator 78. High speed shaft may also be connected to an emergency brake 76, such as a mechanical disk break, in case of system failure or for performing routine maintenance work.

Generator 78 is an electrical generator, and typically an induction or asynchronous generator capable of an electric output of 100 to 3500 kilowatts (kW). Generator 78 converts mechanical energy to electrical energy. Generator 78 is atypical with respect to other generating units attached to the electrical or power grid as generator 78 has to work with a power source (the wind turbine rotor) which supplies very fluctuating mechanical power (torque from wind driven blades 36). Wind turbine 12 may be designed with either synchronous or asynchronous generators, and with various forms of direct or indirect grid connection of generator 78. Direct grid connection means that generator 78 is connected directly to the (usually 3-phase) alternating current grid. Indirect grid connection means that the current from the turbine passes through a series of electric devices which adjust the current to match that of the grid. With an asynchronous generator this occurs automatically.

The size of generator 78 will depend on the size of blades 36, which in turn affects the height of the structure supporting wind turbine 12. For example, 225 kW, 600 kW, and 1,500 kW generators may have approximate rotor diameters of 27, 43, and 60 meters, respectively. This will translate into taller minimum tower requirements for each generator 78.

Generator 78 needs cooling while in operation. On a typical turbine, cooling is accomplished by encapsulating the generator in a duct, using a large fan for air cooling, all of which are contained in cooling unit 86. Cooling unit 86 may also contain an oil cooling component to cool the oil used in gearbox 72. In an alternate embodiment, generator 78 uses a water cooled system with a radiator as cooling unit 86.

Nacelle 38 also houses yaw mechanism 80, which uses electrical motors to turn nacelle 38 and blades 36 so that blades 36 face the optimal direction in relation to the wind. Yaw mechanism is operated by electronic controller 82, which is connected to wind vane and anemometer 88. Anemometer and wind vane 88 measure the speed and direction, respectively, of the wind. Electronic signals from anemometer and wind vane 88 are sent to electronic controller. If a malfunction is sensed, or if wind is exceeding a set speed such as 25 meters per second, electronic controller 82 will stop wind turbine 12 to protect wind turbine 12 and the surrounding area. Wind vane signals are by the electronic controller 82 to turn and angle the blades 36 through use of yaw mechanism 80.

Electronic control 82 is also connected to hydraulic system 84, which drives brake 76 connected to high speed shaft 74. In one embodiment, low speed shaft 70 contains infrastructure such as tubing for hydraulic system 84 to enable brake 76 to act on both high speed shaft 74 and low speed shaft 70.

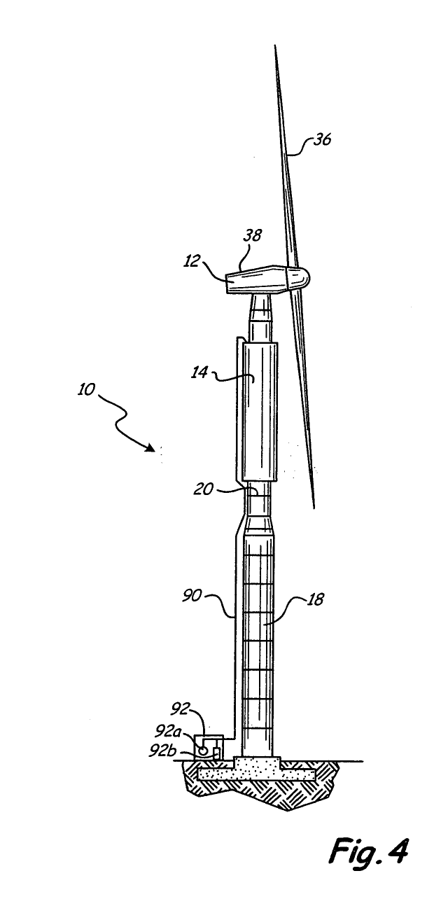

FIG. 4 is an elevation view of another embodiment of combination tower 10 with wind turbine 12 and elevated storage tank 14. Illustrated are combination tower 10 having first elevating section 18 and second elevating section 20, blades 36, nacelle 38, as well as utility line 90 and utility housing 92. In this embodiment, elevated storage tank 14 is an elongated tank with a small cross sectional area contained within second elevating section 20. First elevating section 18 will contain an outlet pipe connected to the bottom of elevated storage tank 14. When elevated storage tank is filled with water, the tank will create hydraulic pressure into the outlet pipe, which is in communication with a water delivery system.

The elongated design of elevated storage tank 14 minimizes the horizontal cross sectional area. This leaves the contents of the tank less area to shift or move due to motion from wind turbine 12. The elongated design will still allow for the creation of adequate pressure for an attached water system, while minimizing the stress experienced on first elevating section 18.

Elevated storage tank 14 may contain a liner (not illustrated) to protect the contents. In an alternate embodiment, elevated storage tank 14 contains a series of baffles that prevent excessive motion of the contents of elevated storage tank due to vibrations and motion caused by the normal operation of wind turbine 12. The liner may also act to reduce the motion of the contents of elevated storage tank 14.

Utility line 90 is a housing for pipes, cables, wires, and similar items. In one embodiment, utility line 90 has an inlet pipe that exits above, and is used to fill elevated storage tank 14. Preferably, the inlet pipe is constructed from PVC or similar dielectric material. Utility line 90 may also carry insulated wires that transmit the electrical power generated by wind turbine 12 to the power grid. In an alternate embodiment, utility line 90 is run through the center of combination tower 10 rather than on the exterior as illustrated.

Utility housing 92 accommodates components associated with wind turbine 12 and elevated storage tank 14. For instance, utility housing 92 may contain one or more pumps 92a that transport water through a pipe in utility line 90 to fill elevated storage tank 14 with water. Similarly, utility housing 92 may contain one or more transformers 92b, thyristors, and similar electrical components and associated hardware to impart the energy generated in to the power grid. In one embodiment, wind turbine 12 will run at almost constant speed with a direct power grid connection. In one embodiment, a portion of the energy generated may be used to run the pumps 92a that fill elevated storage tank 14.

In an alternate embodiment, wind turbine 12 has an indirect grid connection. Wind turbine runs in its own, separate mini AC-grid. The grid is controlled electronically (e.g. using an inverter), so that the frequency of the alternating current in the stator of the generator may be varied. Thus it is possible to run the turbine at variable rotational speed. Wind turbine 12 will generate alternating current (AC) at exactly the variable frequency applied to the stator. The AC with a variable frequency typically cannot be handled by a normal power or electrical grid. Thus, the AC is converted to direct current (DC) using thyristors or transistors. The DC is then reconverted to AC at the same frequency as the normal power grid. The conversion to AC is also done using thyristors, transistors, transformers, or similar electrical components.

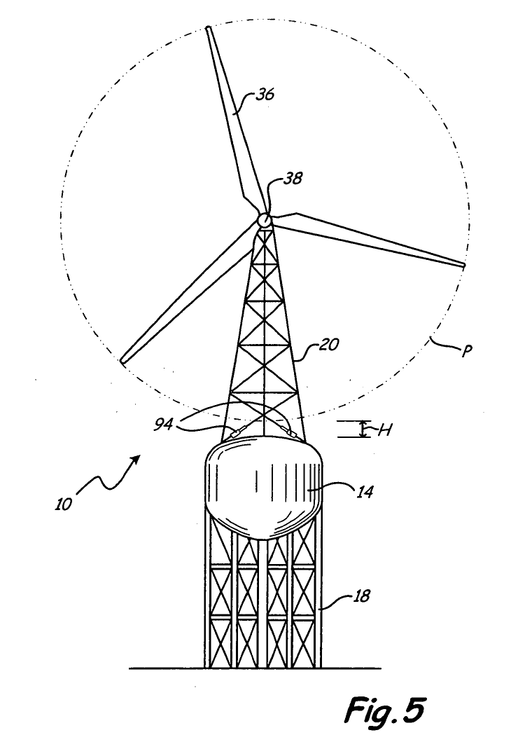

FIG. 5 is an elevation view of another embodiment of combination tower 10 with wind turbine 12 and elevated storage tank 14. Combination tower again has first elevating section 18 and second elevating section 20. Nacelle 38 and blades 36 are affixed to the top of second elevating section 20. Both first elevating section 18 and second elevating section 20 are lattice design. Lattice towers are manufactured using steel beams connected to one another, such as by welding. One advantage of lattice towers is cost, since a lattice tower requires approximately half as much material as a freely standing tubular tower with a similar stiffness.

Second elevating section 20 is attached in part to elevated tank section 14 with shock absorbers 94. Shock absorbers may be air shocks, mechanical springs, or similar structures that will minimize stress on elevated storage tank 14 and first elevating section 18 caused by the movement of second elevating section 20 with respect to elevated storage tank 14 due to turbine operation.

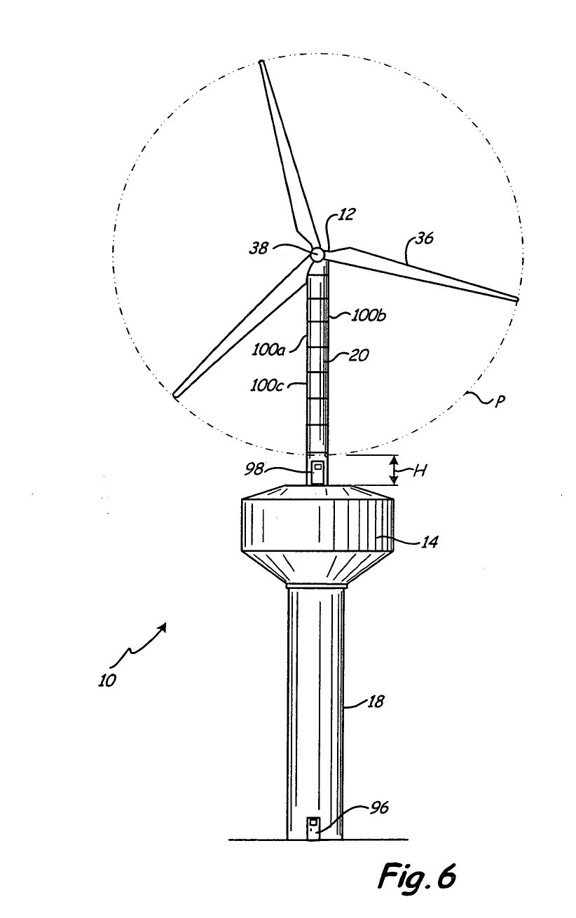

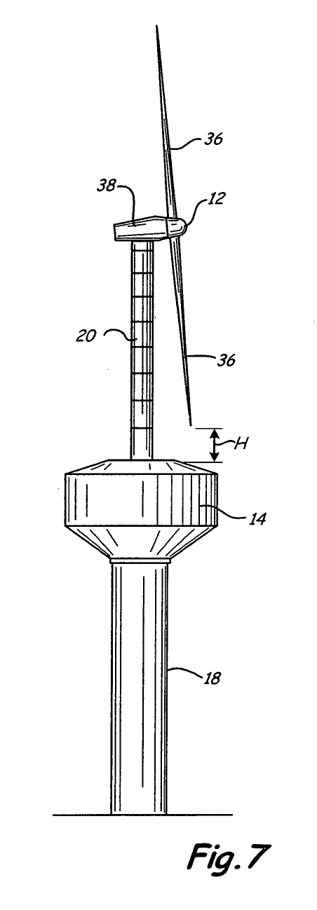

FIG. 6 is an elevation view of another alternate embodiment of the combination tower 10, which again is comprised of wind turbine 12, elevated storage tank 14, first elevating section 18, and second elevating section 20. FIG. 7 is an elevation view of the side of the embodiment of the combination tower 10 illustrated in FIG. 6. In this embodiment, first elevating section 18 is a tower constructed from concrete. Elevated storage tank 14 is also constructed from concrete. In alternate embodiments, elevated storage tank 14 and first elevating section 18 are constructed from a rigid material, such as composites, concrete and cement blends, carbon steel, stainless steel, and may be glass lined, galvanized, or powder coated with a polymer for protection against corrosion. First elevated section is hollow, and the hollow area may extend through elevated storage tank 14. Door 96 allows access to the hollow area of first elevated section. The hollow area may contain offices and control panels for overseeing operation of combination tower 10. Hollow area may also contain pumps, inlet pipes for filling elevated storage tank 14, outlet pipe(s), tank access via a ladder, and similar components commonly associated with water towers. Similarly, hollow area may contain a power transforming system to convert the energy produced by wind turbine 12 to the proper form for introduction into a power grid.

Second elevating section 20 is constructed from a series of annular metal rings 100a-100c attached together, which are manufactured in sections of 5-30 meter with flanges at either end, and bolted together on the site. Second elevating section 20 is illustrated as being generally cylindrical, but may be conical (i.e. with a diameter increasing towards the base) in order to increase the strength and to save materials at the same time. Second elevating section 20 may contain an access door 98 for entering the tower to perform maintenance. This access may be connected to the hollow area of first elevating section 18 which can also be accessed by door 96.

Wind turbine 12 contains blades 36. Second elevating section 20 is sized to that blades 36 are free to rotate about a perimeter P (FIG. 6) without coming into contact with other portions of combination tower 10, including elevated storage tank 14. This point is further illustrated by FIG. 7 where blades 36 are illustrated in a position where blades 36 are generally parallel to second elevating section 20. As illustrated, a gap H exists between the bottom edge of blade 36 and the top of elevated storage tank 14.

Combination tower 10 as illustrated in FIGS. 6 and 7 is constructed using two different materials for first elevating section 18 and second elevating section 20. As previously shown, combination tower may also be constructed using similar materials for first elevating section 18 and second elevating section 20. Any of the disclosed embodiments of the materials for first elevating section 18, second elevating section 20, and elevated storage tank 14 may be combined to create combination tower 10. Similarly, any of the related tank support structures 60, baffles, liners 58, stress reduction pads 62, utility lines 90, shock absorbers 94, access doors 96 and 98, and/or any other components can be incorporated depending upon design criteria.

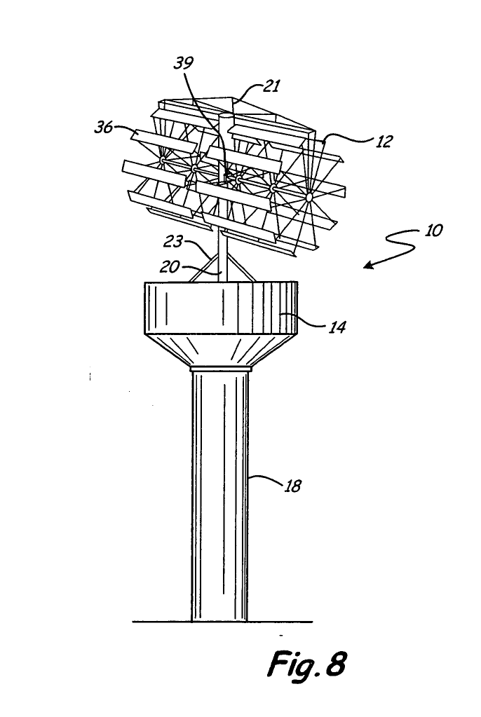

FIG. 8 is an elevation view of another alternate embodiment of combination tower 10. Combination tower 10 has first elevating section 18 supporting tank 14, and second elevating section 20 supporting wind turbine 12. In this embodiment, wind turbine 12 is secured to top of tank 14 through top frame 21 and supports 23. Frame 21 is illustrated as a lattice structure that is attached to the top of second elevating section 20, and extends horizontally therefrom. The ends of frame 21 contain lower extensions that attach and secure the outer edge of the paddle-like wheel constructed from rotary blades 36. Frame 21 is rotatable about the axis of second elevating section to optimize the position of blades 36 with respect to the present prevailing air currents. Supports 23 may be connected with a resilient material between the town and tank to reduce the effect of vibrations from the operation of wind turbine 12 on tank 14. In an alternate embodiment, supports 23 may contain shock absorbers to dampen vibrations from wind turbine 12.

In this embodiment, wind turbine 12 contains a series of blades 36 in paddle-like wheel formations that rotate about an axis that is generally perpendicular to the axis of first elevating section 18 and second elevating section 20. The centers of the paddle-like wheels are attached directly or indirectly to power transmitter 39. In one embodiment, power transmitter 39 may be a pulley, sheave, sprocket, or similar device that allows for the transmission of rotary power to a shaft. In alternate embodiments, power transmitter is a shaft attached to a gear box that will translate the rmp of the shaft up by multiplier, typically by 50 or more, to a high speed shaft that will in turn drives an electrical generator.

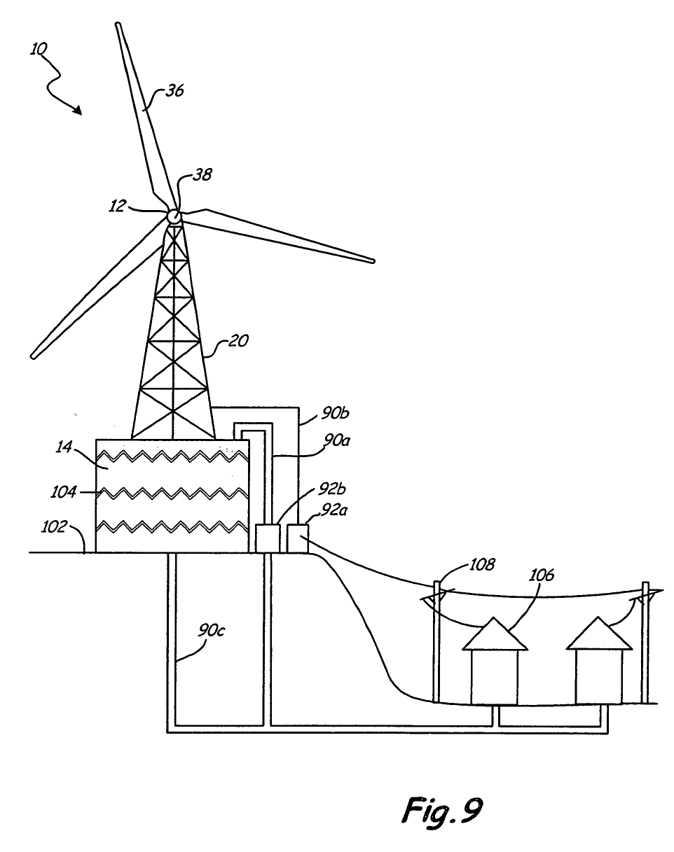

FIG. 9 is an elevation view of an alternate embodiment of combination tower 10 with wind turbine 12 on elevating tower section 20 attached to the top of elevated storage tank 14. In this embodiment, elevated storage tank 14 is placed upon higher elevation ground 102 than the buildings 106 and structures that will utilize the contents of elevated storage tank 14. Second elevating section 20 is attached to the top surface of elevated storage tank 14. Wind turbine 12 having blades 36 and nacelle 38 is attached to the top of second elevating section 20. Elevated storage tank 14 is used as a first elevating section to support second elevating section 20 and wind turbine 12.

Elevated storage tank contains a series of baffles 104. Baffles 104 are illustrated as corrugated sheets of material. Baffles 104 may extend between the walls of elevated storage tank 14 and cover a portion of the surface area of a cross section of elevated storage tank 14 to allow a fluid to flow therein. In an alternate embodiment, the baffles are flat sheets of material that cover substantially the entire surface area of a cross section within elevated storage tank 14, and contain apertures to allow the flow of fluids through baffle 104. Baffles 104 minimize the flow of contents of elevated storage tank 14, and provide structural support to prevent the tank from collapsing due to vibrations and other forces caused by operation of the attached wind turbine 12.

Also illustrated in FIG. 9 are utility lines 90a-90c and utility housings 92a-92b. Utility housing 92b contains one or more pumps that transport water through a pipe in utility line 90a to fill elevated storage tank 14 with water. Once filled, elevated storage tank will create pressure in a pipe within utility line 90c which is connected to the buildings 106 or other structures requiring the contents. Utility housing 92a accommodates components associated with wind turbine 12, which may contain one or more transformers, thyristors, and similar electrical components and associated hardware to impart the energy generated in to power grid 108. Power generated by wind turbine 12 is transmitted to utility housing 92a through utility line 90b, which is an insulated wire in one embodiment. The components in utility housing 92a will convert the energy received from wind turbine 12 and transmit the energy as usable power via power grid 108. In the embodiment illustrated, power grid 108 contains a series of utility poles and utility wires, with utility wires running between adjacent poles, and from the utility poles to buildings 106.

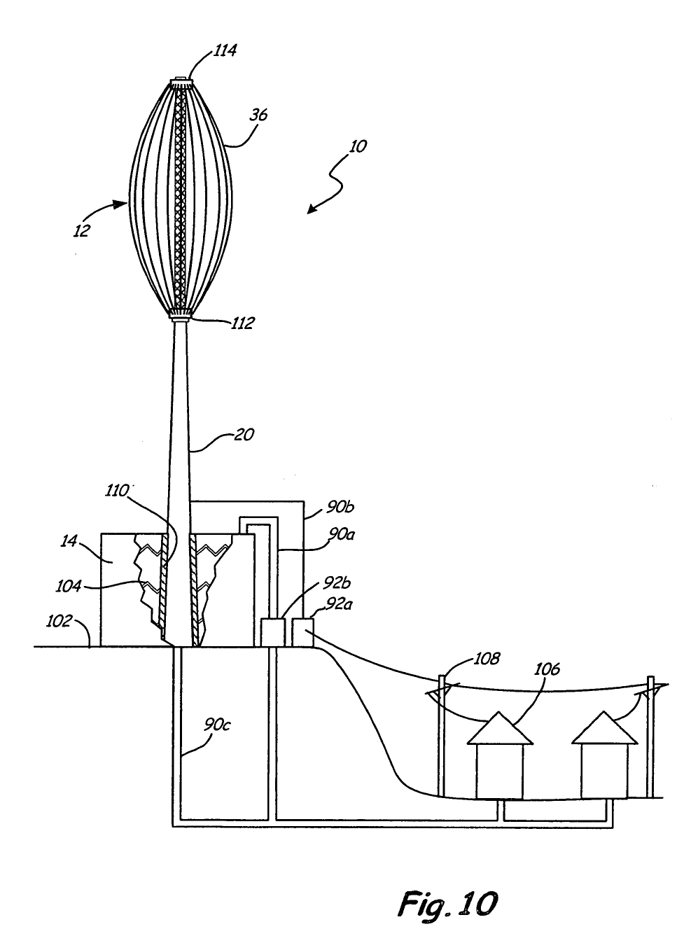

FIG. 10 is an elevation view of an alternate embodiment of a partial cross section of elevated storage tank 14 with wind turbine 12 attached to the top of tower section 20 extending above elevated storage tank 14. Also illustrated are utility lines 90a-90c, utility housings 92a-92b, buildings 106, and power grid 108, which have been previously described.

In this embodiment, elevated storage tank 14 surrounds tower section 20. Tower section 20 and elevated storage tank 14 share a common footprint on higher elevation ground 106, thus conserving on space required for utilities in an area such as a municipality. The portion of tower section 20 that is coextensive with elevated storage tank 14 has buffer 110 between the two components. In one embodiment, buffer 110 is a resilient dielectric material that acts to insulate the contents of elevated storage tank 14 as well as provide shock absorption between the components due to normal operation of wind turbine 12. Baffles 104 are located in the interior of elevated storage tank 14. Baffles 104 have been previously described, and in one embodiment are attached to interior surface of elevated storage tank 14. In an alternate embodiment, baffles 104 are attached to either buffer 110 or tower section 20 and the interior surface of elevated storage tank 14.

Wind turbine 12 is of a different design, and contains a series of arcuate blades 36 that adjoin pivoting hubs 112, 114. As air moves, it will strike the blades 36 and cause the blade assembly to turn pivoting hubs 112, 114 that are coaxial with elevating section 20. In this embodiment, the coaxial rotation with the elevating section is translated to a generator to harvest power from air currents or wind.

Combination tower 10 as disclosed has several advantages. Only a single tower structure would be required for constructing a water tower and wind turbine tower. This saves on the cost of constructing two separate towers, including design and engineering costs. Also, a single tower reduces the area required for constructing an elevated storage tank 14 and wind turbine 12 as only one rather than two footprints for the base or footing will be required.

Although water and power are two common utilities, each typically has different ownership. With the present invention, two separate parties could pool resources to save costs for the construction of a water tower and wind turbine. For example, one party (a municipality, university, township, farm/ranch, etc.) may require a new water tower. A power company may cover some of the cost associated with construction provided that the company may utilize the water tower structure as a portion of a wind turbine structure. The relationship could be a “condominium” type agreement where one party owns the elevated storage tank 14 and associated system, while another party owns the wind turbine 12, and the elevating sections 18 and 20 of combination tower 10 are commonly owned. Each party would be responsible for maintenance of their own interest as well as the common interest. In such an arrangement, the owner of the elevated storage tank 14 would agree to allow for the placement of cables, wires, and other necessary power transmission components along side or within its portion of the tower. Similarly, access rights to the turbine would be granted. The turbine access and power transmission requirements are designed to be minimally intrusive upon the elevated storage tank design and operation. In one embodiment, the owner of the wind turbine 12 may sell power generated to the owner of the elevated storage tank 14 for operation of the associated water system.

The design of combination tower 10 should include adequate protections to assure power generation does not affect the contents or operation of elevated storage tank 14. This would include assuring that the tower is structurally sound and can withstand all forces created from the wind and wind harvesting, as well as the filling and emptying of the elevated storage tank 14. Similarly, protections should be in place to assure that power generated does not enter the contents of elevated storage tank 14. By utilizing non-conducting or low conducting materials for the liner, supports, baffles, inlet and outlet pipes, this minimizes the possibility of electricity produced by wind turbine 12 from affecting contents of elevated storage tank 14, especially water. Proper placement and design of power transmission lines from the turbine will equally minimize potential problems. Combination tower 10 is designed as a whole to support both elevated storage tank 10 and wind turbine 12, while isolating individual aspects of each to prevent interference with the other's usual operation.

The design of combination tower 10 will depend on the relative sizes of the water system and elevated storage tank 14 as well as the size of the turbine. For example, a typical 1000 kW wind turbine will have a tower of between 50-80 meters high. By placing the turbine on top of an existing structure that contains an elevated tank, a large portion of the height is already achieved with the tower structure. This in turn saves much of the expense associated with the lower tower portion.

Although the present invention has been described with reference to preferred embodiments, workers skilled in the art will recognize that changes may be made in form and detail without departing from the spirit and scope of the invention. For instance, any of the disclosed embodiments of the materials for first elevating section 18, elevating section 20, and elevated storage tank 14 may be combined to create combination tower 10. Any turbine 12 and any style blade 36 disclosed may be combined with the various disclosures of the elevated storage tank 14. Similarly, any of the related tank support structures 60, baffles, liners 58, stress reduction pads 62, utility lines 90, shock absorbers 94, access doors 96 and 98, buffer 110, and/or any other components can be incorporated depending upon design criteria.

1. A combination tower comprising:
a first elevating section;
a second elevating section;
a storage tank located above the first elevating section; and
a wind turbine attached to a top of the second elevating section;
wherein the first elevating section is capable of supporting the second elevating section, storage tank, and wind turbine.

2. The combination tower of claim 1 further comprising:
a connection between the second elevating section and the storage tank that minimizes stress in the structure of the tank due to wind turbine operation.

3. The combination tower of claim 1 wherein the storage tank further comprises:
a dielectric liner covering an interior surface of the tank.

4. The combination tower of claim 3 wherein the storage tank further comprises:
a plurality of support beams extending between two points on the interior surface of the tank.

5. The combination tower of claim 1 wherein the storage tank is a water storage tank.

6. The combination tower of claim 1 further comprising:
an access passage which extends through the first elevating section and the second elevating section.

7. A utility system, the system comprising:
an elevated storage tank;
a tower section extending above the elevated storage tank;
a wind turbine attached to a top of the tower section for generating electrical power;
a water system including the storage tank, an inlet pipe into the storage tank, and outlet pipe for discharging a fluid from the storage tank; and at least one pump connected to the inlet pipe for pumping the fluid into the storage tank.

8. The utility system of claim 7 further comprising:
a power transforming system capable of introducing the electrical power generated by the wind turbine into a power grid.

9. The utility system of claim 7 wherein a portion of the power generated by the wind turbine is used to operate the water system.

10. The utility system of claim 7 wherein the connection between the tower section and the storage tank minimizes stress in the structure of the tank due to wind turbine operation.

11. The utility system of claim 7 wherein the wind turbine is owned by a first party, and the water system is owned by a second party.

12. The utility system of claim 7 wherein the storage tank further comprises:
a dielectric liner covering an interior surface of the tank.

13. The utility system of claim 7 wherein the storage tank further comprises:
a series of baffles that extend over a portion of a cross sectional area of the elevated storage tank.

14. The utility system of claim 7 wherein the tank is designed to support the tower section and the wind turbine.

15. A combination tower comprising:
a first elevating section comprising an elevated water storage tank, the first elevating section being used as a water tower;
a second elevating section having a wind turbine attached to a top portion thereof;
wherein the second elevating section is supported above the first elevating section in such a manner as to reduce the stress associated with operation of the wind turbine from substantially affecting the operation and stability of the first elevating section.

16. The combination tower of claim 15 wherein the elevated water storage tank further comprises:
a plurality of support beams extending between two points on the interior surface of the tank.

17. The combination tower of claim 15 wherein the elevated water storage tank contains a plurality of baffles to minimize motion of the water within the elevated water storage tank.

18. The combination tower of claim 15 wherein the first elevating section and the second elevating section are constructed from different materials.

19. The combination tower of claim 15 wherein an interior surface of the elevated water storage tank is lined with a dielectric material.

20. The combination tower of claim 15 further comprising:
an access passage which extends through the first elevating section and the second elevating section.
